(19) United States
(12) Patent Application Publication
(10) Pub. No.: US 2009/0295801 A1
(43) Pub. Date: Dec. 3, 2009

(54) Method for visualizing tubular anatomical structures, in particular vessel structures, in medical 3D image records

(76) Inventors: Dominik Fritz, Karlsruhe (DE); Michael Scheuering, Nürnberg (DE); Johann Uebler, Nürnberg (DE)

Correspondence Address: HARNESS, DICKEY & PIERCE, P.L.C., P.O.BOX 8910, RESTON, VA, 20195, US

(21) Appl. No.: 12/453,949

(22) Filed: May 28, 2009

(30) Foreign Application Priority Data
May 28, 2008 (DE) 10 2008 025 535.1

(51) Int. Cl. G06T 17/40

(52) U.S. Cl. 345/424; 382/128

(57) ABSTRACT

A method is disclosed for visualizing tubular anatomical structures, in particular vessel structures, in medical 3D image records. In at least one embodiment, the method includes the following: firstly, providing 3D image data of the tubular anatomical structure; secondly, displaying a first image of the tubular anatomical structure on the basis of the 3D image data; thirdly, selecting an image voxel which is assigned to the tubular structure in the 3D image data on the basis of the first image; fourthly, determining a centerline of the tubular anatomical structure in a prescribably delimited region of the 3D image data comprising the image voxel; fifthly, selecting a point of the centerline; sixthly, generating one or more 2D slice images assigned to the point, the 2D slice images in each case representing a sectional plane in the 3D image data; and seventhly, displaying the 2D slice images.

### PRIORITY STATEMENT

The present application hereby claims priority under 35 U.S.C. §119 on German patent application number DE 10 2008 025 535.1 filed May 28, 2008, the entire contents of which are hereby incorporated herein by reference.

The present application is generally related to an application entitled “METHOD AND APPARATUS FOR VISUALIZING TUBULAR ANATOMICAL STRUCTURES, IN PARTICULAR VESSEL STRUCTURES, IN MEDICAL 3D IMAGE RECORDS” filed in the USPTO on the same date as the present application and claiming priority to German patent application numbers DE 10 2008 025 537.8 filed May 28, 2008, and DE 10 2009 014 764.0 filed Mar. 25, 2009, the entire contents of each of which is hereby incorporated herein by reference.

### FIELD

At least one embodiment of the present invention is generally in the field of medical technology and generally relates to a method and/or an apparatus for visualizing tubular anatomical structures, in particular vessel structures, in medical 3D image records. Such 3D image records, or corresponding 3D image data, can be obtained in at least one embodiment using known medical imaging techniques, such as computed tomography (CT), nuclear magnetic resonance imaging (NMRI), magnetic resonance imaging (MRI) or sonography. Here, a stack of 2D slice image records of an examination object, which includes the tubular anatomical structure, is typically generated. Hence, the stack of 2D slice image records constitutes the 3D image data.

### BACKGROUND

These days, medical 3D image records are predominantly evaluated using visually displayed 2D slice images which are generated on the basis of the recorded 3D image data. This practice is also applied if the structures to be analyzed in the 3D image records have a tubular geometry. Examples of tubular structures include tubular hollow organs, such as the colon, or vessels, such as e.g. the aorta or the coronary vessels. In the latter cases, the evaluation of the tubular structures is particularly focused on analyzing pathological changes, usually on the inner walls of the tubular structure. A stenotic region in a vessel section is mentioned here in an exemplary manner. From a medical point of view, it is the goal in this case to find out to what extent the narrowed region influences the overall medical function of the vessel section. In the present example of narrowing vessels, this means that the medical practitioner analyzes the 3D image records to determine whether enough blood can still flow through the vessel, despite the narrowing of the vessel, so that e.g. the myocardium still has a sufficient supply of oxygen.

For the evaluation of tubular structures, the prior art discloses the determination of a centerline in the recorded 3D image data, which centerline represents the three-dimensional tubular structure imaged in the 3D image data. To this end, the prior art uses known skeletonizing or thinning methods. Here, this centerline is used as a “path” for the visualization of the tubular anatomical structure using 2D slice images. This means that for a point of the centerline which can be selected manually, one 2D cross section of the tubular structure, which is orthogonal to the centerline at the selected point, and two 2D slice images with tangential sectional planes are generally calculated and displayed visually. Usually, the sectional planes of the 2D cross section and the two 2D slice images are arranged orthogonally with respect to one another. By repeatedly selecting points of the centerline, corresponding 2D slice images and/or 2D cross sections, respectively assigned to the selected points, are generated and displayed. Particularly when continuously selecting adjacent points of the centerline, corresponding to, for example, continuous motion back and forth along the centerline, the tubular structure can be continuously evaluated using the 2D slice images respectively displayed in the process.

Known methods have the following problems: the determination of the centerline is connected to a significant expenditure of time in the known methods. Often, it is not possible to completely determine all centerlines, for example in the case of extensively branched vessel structures, so that complicated post-segmenting is necessary in these cases.

### SUMMARY

In at least one embodiment of the invention, a method is specified for visualizing tubular anatomical structures, in particular vessel structures, in medical 3D image records in which the problems described above are avoided and a faster and more reliable evaluation of tubular anatomical structures is made possible.

According to at least one embodiment of the invention, the method for visualizing tubular anatomical structures, in particular vessel structures, in medical 3D images has the following steps:

Step a): Providing 3D image data of the tubular anatomical structure. Here, the 3D image data was typically produced using a medical imaging method, such as computed tomography, nuclear magnetic resonance imaging, magnetic resonance imaging or sonography. In principle, the method can be applied to all 3D image data in which tubular structures intended to be examined are imaged.
Step b): Displaying a first image of the tubular anatomical structure on the basis of the 3D image data. The display is typically effected on a monitor or a screen. It goes without saying that further display means known to the person skilled in the art are suitable to this end. In the process, the first image can be displayed in any display format of the tubular anatomical structure, such as a 2D slice image, a volume illustration, etc.
Step c): Selecting an image voxel V which is assigned to the tubular structure in the 3D image data on the basis of the first image. The image voxel V can be selected automatically or by manual entry. Manual selection of the image voxel V is preferably carried out by an operator using an input unit, such as a computer mouse, a keyboard, a slider or a voice control unit.
Step d): Determining a centerline of the tubular anatomical structure only in a prescribably delimited region of the 3D image data comprising the image voxel V. Thus, instead of being determined in the entire 3D image data, the centerline is only determined in a very confined part of the 3D image data. The delimited region of the 3D image data is preferably defined by a prescribably locally delimited volume region in the object space, that is to say in the space of the imaged object with the tubular structure. In principle, the locally delimited volume region in the object space can have an arbitrary shape. In one embodiment of the method, the locally delimited volume region in the object space has a spherical shape which is defined by a radius r around the position of the image voxel V in the object space. In this case, all 3D image voxels whose distance from the image voxel V in the object space is less than or equal to the radius r belong to the delimited region of the 3D image data. In an alternative embodiment of the method, the locally delimited volume region in the object space has a boundary in the form of a polyhedron, in particular in the form of a cuboid or a cube. Preferably, the dimensions of the locally delimited volume in the object space correspond to a multiple of, in particular five to thirty times, the maximum cross section of the tubular anatomical structure imaged in the 3D image data. Appropriate maximum cross sections are known to a person skilled in the art so that these can, for example, be prescribed in the form of a table.

The centerline in the delimited region of the 3D image data is determined using methods known from the prior art, preferably by segmenting and subsequent skeletonizing, or by grayscale analysis.

As a result of determining a short centerline piece in the delimited region of the 3D image data, the computational complexity connected to this or the time expenditure accompanying this is significantly reduced with respect to the prior art.

Step e): Selecting a point F of the centerline. The point F can be selected automatically or by a manual input. Manual selection of the point F is preferably effected by an operator using an input unit, for example a computer mouse, a keyboard, etc.
Step f): Generating one or more 2D slice images assigned to the point F, the 2D slice images in each case representing a sectional plane in the 3D image data. The sectional planes are preferably arranged orthogonally with respect to one another.
Step g): Displaying the 2D slice images. In step g), the 2D slice images are preferably displayed on one or more monitors or screens.

Hence, in order to visualize a 3D image record of a tubular anatomical structure, an image voxel V assigned to the imaged tubular structure is first of all prescribed (selected). Subsequently, starting from the image voxel V, a centerline is determined in the delimited region of the 3D image data, preferably along both directions of the longitudinal extent of the observed tubular structure, by e.g. searching for the locally most favorable path. Alternatively, the centerline can also be determined, starting from the image voxel V, in only one direction along the tubular structure. Once the centerline has been determined, a point F of the centerline is selected and, for example, orthogonal and/or tangential sectional planes are determined and displayed for the point.

In order to enable continuous evaluation of the tubular structure along the determined centerline, the method is particularly advantageously repeatedly run through after step g), starting with step e). The renewed selection of a new point F is effected, for example, by means of the mouse wheel of a computer mouse or by means of a keyboard. Hence, a diagnosing medical practitioner, starting from an initial position of the point F, can again set the point F along the centerline by a defined interaction. If the respectively adjacent points F of the centerline are selected in the process, this effects a continuous “migration” along the centerline, with corresponding 2D slice images being determined and displayed for every selected point F.

If a different location of the tubular structure imaged in the 3D image data is intended to be evaluated, for which location no centerline has been determined until now, the method is preferably repeatedly run through after step g), starting with step c), with it being possible to effect the renewed selection of an image voxel V assigned to the tubular structure on the basis of the first image or on the basis of a 2D slice image displayed in step h).

An advantage of at least one embodiment of the described method results from the fact that 3D image data can be visualized interactively in a very quick fashion, without segmenting and skeletonizing all of the 3D image data. If the determination of a centerline fails using a conventional method, or the computational time required for this is very long, it is no longer possible to sensibly evaluate the tubular structure interactively. It is precisely in this scenario that the method according to the invention is advantageous. The method according to at least one embodiment of the invention makes it possible to interactively evaluate every tubular structure in real time. As a result of the interactive method of operation, the visualizing of the 3D image data can be influenced and corrected at any time whilst “migrating” along the centerline by “clicking” a new position in the displayed image of the tubular structure (this corresponds to selecting a new image voxel V in step c)) and hence another section of the tubular structure can be visualized.

In order to avoid a “jumping” of the display of the 2D slice images when selecting a new image voxel (V) or a new point (F), the new locally determined 2D slice images are advantageously not displayed immediately, but rather the display is morphed into these, starting from the previously illustrated 2D slice images. This is preferably effected by a gradual interpolation of the sectional images between the new and previous 2D slice images.

The described interactive method permits faster evaluation, is significantly more user friendly and hence more efficient than known methods.

### BRIEF DESCRIPTION OF THE DRAWINGS

Example embodiments of the invention and further advantageous refinements of the invention are illustrated in the following schematic drawings, in which:

FIG. 1 shows a schematic illustration of the tubular structure 201 imaged in the 3D image data 200 in the object space,

FIG. 2 shows a schematic illustration of the image voxel V and the locally delimited volume region 202 in the object space,

FIG. 3 shows a schematic illustration of the centerline 203 determined in the delimited region of the 3D image data 200 in the object space,

FIG. 4 shows a schematic flowchart of the method according to an embodiment of the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

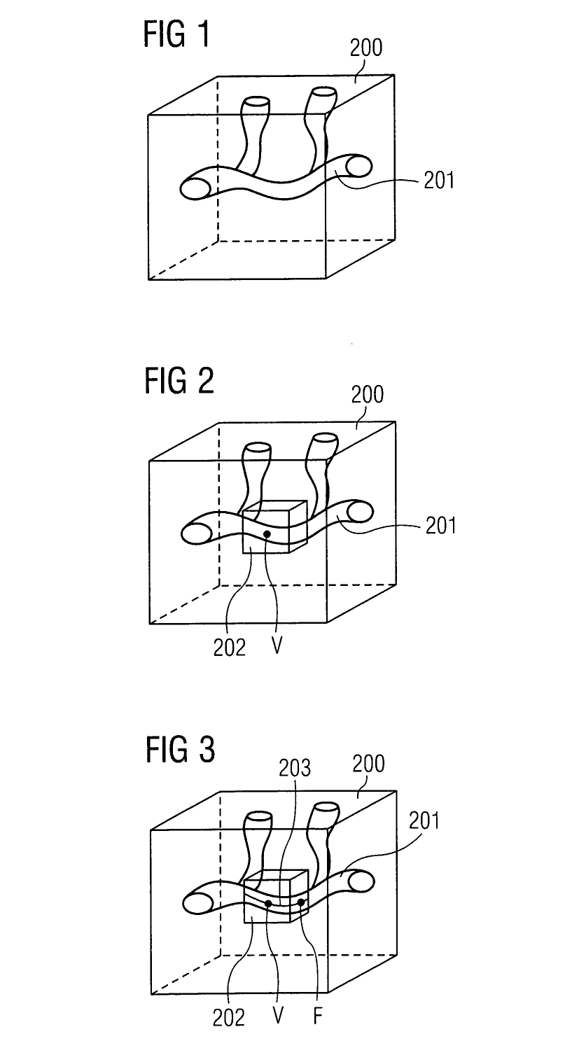

FIG. 1 shows a schematic illustration of the tubular structure 201 imaged in the provided 3D image data 200 in the object space.

In addition to FIG. 1, FIG. 2 shows the image voxel V selected within the tubular structure 201 and, dependent thereon, the prescribed locally delimited volume region 202 in the object space. In the present case, the locally delimited volume region 202 is in the shape of a cube. The dimensions of the cube and the dimensions of the locally delimited volume region 202 are preferably a multiple of, in particular five to thirty times, the maximum cross section of the tubular anatomical structure imaged in the 3D image data. However, these spatial relations cannot be seen in FIG. 2.

In addition to FIG. 2, FIG. 3 shows the centerline 203 determined for the delimited region of the 3D image data 200, and the point F selected along the centerline 203 in the object space. FIG. 3 illustrates the special case in which the image voxel V lies on the centerline 203. As already explained above, the image voxel V is selected in method step c) as a pixel belonging to the tubular structure 201. Subsequently, the centerline 203 of the tubular structure 201 is determined as a function of the image voxel V in a prescribably delimited region of the 3D image data including the image voxel V. Hence, the image voxel V does not, in general, lie on the determined centerline 203.

In method step f), 2D slice images of the 3D image data 200 are determined for the point F selected on the centerline 203. By repeatedly running through method steps e) to g), it is thus possible to evaluate the tubular structure along the centerline 203.

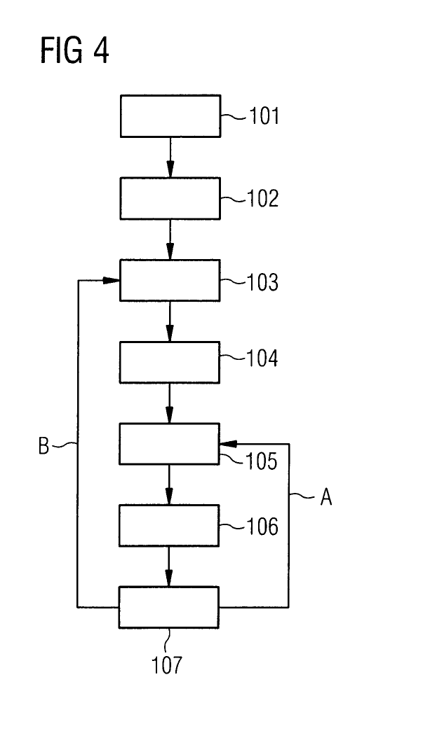

FIG. 4 shows a schematic flowchart of the method according to an embodiment of the invention. 3D image data of the tubular anatomical structure is provided in step 101. A first image of the tubular anatomical structure on the basis of the 3D image data is displayed in step 102. An image voxel V assigned to the tubular structure is selected in step 103 on the basis of the first image in the 3D image data. In step 104, a centerline of the tubular anatomical structure is determined in a prescribably delimited region of the 3D image data comprising the image voxel V. A point F of the centerline is selected in step 105. One or more 2D slice images assigned to the point (F) are generated in step 106, the 2D slice images respectively representing a sectional plane in the 3D image data. The 2D slice images are displayed in step 107. The reference symbol A signifies that the method repeats after step 107, starting with step 105. The reference symbol signifies that the method repeats after step 107, starting with step 103.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for visualizing tubular anatomical structures in medical 3D image records, comprising:
a) providing 3D image data of the tubular anatomical structure;
b) displaying a first image of the tubular anatomical structure on the basis of the 3D image data;
c) selecting an image voxel, assigned to the tubular anatomical structure in the 3D image data, on the basis of the displayed first image;
d) determining a centerline of the tubular anatomical structure only in a prescribably delimited region of the 3D image data including the selected image voxel, the region in the 3D image data in the object space corresponding to a volume region whose dimensions are in each case delimited by equaling 5 to 30 times a maximum cross section of the tubular anatomical structure;
e) selecting a point of the determined centerline;
f) generating one or more 2D slice images assigned to the selected point, the 2D slice images in each case representing a sectional plane in the 3D image data; and
g) displaying the generated one or more 2D slice images.

2. The method as claimed in claim 1, wherein the method is repeatedly run through after step g), starting with step e).

3. The method as claimed in claim 1, wherein the method is repeatedly run through after step g), starting with step c), the image voxel being selected on the basis of the first image or on the basis of a 2D slice image displayed in step g).

4. The method as claimed in claim 1, wherein the centerline is determined in step d) by segmenting and subsequent skeletonizing.

5. The method as claimed in claim 1, wherein the centerline is determined in step d) by grayscale analysis.

6. The method as claimed in claim 1, wherein the locally delimited volume region in the object space is defined by a radius around the position of the image voxel in the object space.

7. The method as claimed in claim 1, wherein the locally delimited volume region in the object space has a boundary in the form of a polyhedron.

8. The method as claimed in claim 1, wherein at least one of the image voxel and the point is selected interactively by an operator using a keyboard, computer mouse or slider.

9. The method as claimed in claim 1, wherein the 2D slice images assigned to the point represent sectional planes which are arranged orthogonally with respect to one another.

10. The method as claimed in claim 2 wherein the method is repeatedly run through after step g), starting with step c), the image voxel being selected on the basis of the first image or on the basis of a 2D slice image displayed in step g).

11. The method as claimed in claim 2, wherein the centerline is determined in step d) by segmenting and subsequent skeletonizing.

12. The method as claimed in claim 2, wherein the centerline is determined in step d) by grayscale analysis.

13. The method as claimed in claim 2, wherein the locally delimited volume region in the object space is defined by a radius around the position of the image voxel in the object space.

14. The method as claimed in claim 2, wherein the locally delimited volume region in the object space has a boundary in the form of a polyhedron.

15. The method as claimed in claim 2, wherein at least one of the image voxel and the point is selected interactively by an operator using a keyboard, computer mouse or slider.

16. The method as claimed in claim 2, wherein the 2D slice images assigned to the point represent sectional planes which are arranged orthogonally with respect to one another.

17. A computer readable medium including program segments for, when executed on a computer device, causing the computer device to implement the method of claim 1.

18. A computer readable medium including program segments for, when executed on a computer device, causing the computer device to implement the method of claim 2.

19. A computer readable medium including program segments for, when executed on a computer device, causing the computer device to implement the method of claim 3.

20. The method of claim 1, wherein the tubular anatomical structures are vessel structures.
